(19) United States
(12) Patent Application Publication
(10) Pub. No.: US 2004/0005023 A1
(43) Pub. Date: Jan. 8, 2004

(54) Apparatus and method of generating frame sync signal of mobile terminal

(76) Inventors: Chang-Shik Ham, Seoul (KR); Sung-Hun Jung, Seongnam-si (KR); Seok-Joong Kim, Yong in-si (KR); Hyun-Sik Tae, Gwacheon-si (KR)

Correspondence Address: Robert E. Bushnell, Suite 300, 1522 K Street, N.W., Washington, DC, 20005-1202, US

(21) Appl. No.: 10/453,510

(22) Filed: Jun. 4, 2003

(30) Foreign Application Priority Data
Jul. 2, 2002 (KR) 02-37868

(51) Int. Cl. H04L 7/00

(52) U.S. Cl. 375/368

(57) ABSTRACT

A method of generating a frame sync signal of a mobile terminal is provided. The mobile terminal includes an input unit, which receives through an I-channel and a Q-channel frames into which a data frame transmitted from a base station is divided; a preamble detection unit, which detects timing information of the base station from a preamble pattern of the received frames; a frame sync pattern detection unit, which receives the frame through the I-channel and an output of the preamble detection unit and verifies the timing information; and a frame sync signal generation unit, which generates a frame sync signal according to an output of the frame sync pattern detection unit.

### CLAIM OF PRIORITY

This application claims the priority to an application entitled “METHOD OF GENERATING FRAME SYNC SIGNAL OF MOBILE TERMINAL” filed in the Korean Intellectual property Office on Jul. 2, 2002 and assigned Serial No. 2002-37868, the contents of which are hereby incorporated herein by reference.

### BACKGROUND OF THE INVENTION

1. Technical Field

The present invention relates to mobile communication, and more particularly, to a method and apparatus for synchronizing a mobile terminal with a base station.

2. Related Art

A base station may communicate with a mobile terminal using time division duplexing (TDD), in which a single frame is divided into a transmission part and a reception part in a time domain and two-way communication is accomplished using a single frequency. For communication, the base station determines time division duplexing (TDD) frames for transmission and time division duplexing (TDD) frames for reception using time information that the base station has. At an initial stage, the mobile terminal does not have the time information that the base station has. Thus, the mobile terminal acquires the time information of the base station by generating a frame sync signal from a received signal using a synchronizing structure, and generates time information for transmission and reception by the mobile terminal for communication.

Exemplars of recent efforts in the art of communications include U.S. Pat. No. 5,485,489 to Chiba, entitled CARRIER RECOVERY CIRCUIT FOR OFFSET QPSK DEMODULATORS, issued on Jan. 16, 1996, U.S. Pat. No. 6,253,088 to Wenk et al., entitled PERSONAL BASE STATION FOR INTEGRATED CELLULAR AND CORDLESS COMMUNICATIOIN SYSTEM, issued on Jun. 26, 2001, U.S. Pat. No. 6,400,734 to Weigand, entitled METHOD AND ARCHITECTURE FOR TDMA RECEIVER INCORPORATING A UNIQUE WORD CORRELATION CONTROL LOOP, issued on Jun. 4, 2002, U.S. Pat. No. 6,480,559 to Dabak, entitled FRAME SYNCHRONIZATION WITH UNIQUE-WORD DEPENDENT FILTER COEFFICIENTS, issued on Nov. 12, 2002, and IEEE document authored by David Schafer and entitled “Physical Layer Protocol Based on a Time Division Duplex/Time Division Multiple Access (TDD/TDMA) Frame Structure”. While these recent efforts provide advantages, we believe that further improvements can be contemplated.

A frame sync pattern may not be detected at all or may be detected at different time positions according to a channel environment, so an undesirable situation such as a false alarm, a detection miss, or a sync-lost may occur. It would be desirable to develop a new and improved apparatus and method of generating frame sync signals of mobile terminals which reduces the frequency of false alarms and detection errors.

### SUMMARY OF THE INVENTION

The present invention provides a mobile terminal for synchronizing with a base station and a method of generating a frame sync signal.

The present invention also provides a computer readable recording medium on which a program for executing the method in a computer is recorded.

According to an aspect of the present invention, there is provided a mobile terminal including an input unit, which receives through an I-channel and a Q-channel frames into which a data frame transmitted from a base station is divided; a preamble detection unit, which detects timing information of the base station from a preamble pattern of the received frames; a frame sync pattern detection unit, which receives the frame through the I-channel and an output of the preamble detection unit and verifies the timing information; and a frame sync signal generation unit, which generates a frame sync signal according to an output of the frame sync pattern detection unit.

According to another aspect of the present invention, there is provided a method of generating a frame sync signal using a mobile terminal. The method includes (a) dividing a data frame received from a base station into a frame passing through an I-channel and a frame passing through a Q-channel and inputting the divided frames; (b) down sampling the frame passing through the I-channel and the frame passing through the Q-channel and detecting timing information of the base station; (c) calculating a level of a frame sync pattern of the frame passing through the I-channel; (d) comparing the result of the calculation with a predetermined threshold value; and (e) performing an OR operation on the result obtained in step (b) and the result obtained in step (d) to generate a frame sync signal.

In accordance with the principles of the present invention, as embodied and broadly described, the present invention provides a mobile terminal, comprising: an input unit receiving frames from a base station, said input unit receiving the frames through an I-channel and a Q-channel; a preamble detection unit detecting timing information of the base station from a preamble pattern of the received frames, said preamble detection unit including a plurality of outputs; a frame sync pattern detection unit receiving the frames through the I-channel, receiving the frames from at least one output of said preamble detection unit, and verifying the timing information; and a frame sync signal generation unit generating a frame sync signal in dependence upon an output of said frame sync pattern detection unit.

In accordance with the principles of the present invention, as embodied and broadly described, the present invention provides a method of generating a frame sync signal with a mobile terminal, the method comprising: dividing a data frame received from a base station into a frame passing through an I-channel and a frame passing through a Q-channel, and inputting the divided frames; down sampling the frame passing through the I-channel and the frame passing through the Q-channel, outputting a first signal when a preamble is received, and detecting timing information of the base station; calculating a level of a frame sync pattern of the frame passing through the I-channel; comparing a predetermined threshold value with result of said calculating; and performing an AND operation on the first signal and the result of said comparing, said performing of the AND operation generating the frame sync signal.

In accordance with the principles of the present invention, as embodied and broadly described, the present invention provides a computer-readable medium having a set of computer-executable instructions for performing a method of generating a frame sync signal with a mobile terminal, the set of instructions comprising one or more instructions for: dividing a data frame received from a base station into a frame passing through an I-channel and a frame passing through a Q-channel, and inputting the divided frames; down sampling the frame passing through the I-channel and the frame passing through the Q-channel, outputting a first signal when a preamble is received, and detecting timing information of the base station; calculating a level of a frame sync pattern of the frame passing through the I-channel; comparing a predetermined threshold value with result of said Calculating; and performing an AND operation on the first signal and the result of said comparing, said performing of the AND operation generating the frame sync signal.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a diagram showing a frame structure for a mobile terminal;

FIG. 2 is a block diagram of a mobile terminal generating a frame sync signal, in accordance with the principles of the present invention;

FIG. 3 is a diagram showing the structure of a frame received by a mobile terminal, in accordance with the principles of the present invention;

FIG. 4 is a diagram showing the structure of a matched filter of the mobile terminal shown in FIG. 2, in accordance with the principles of the present invention;

FIG. 5 is a diagram showing the structure of a correlation detector of the mobile terminal shown in FIG. 2, in accordance with the principles of the present invention;

FIG. 6 is a diagram showing the structure of a selector of the mobile terminal shown in FIG. 2, in accordance with the principles of the present invention;

FIG. 7 is a flowchart of a method of generating a frame sync signal, in accordance with the principles of the present invention;

FIG. 8 is a diagram showing a base station and a mobile terminal, in accordance with the principles of the present invention; and

FIG. 9 is a diagram showing a computer system, in accordance with the principles of the present invention.

### DESCRIPTION OF BEST MODE OF CARRYING OUT THE INVENTION

While the present invention will be described more fully hereinafter with reference to the accompanying drawings, in which details of the present invention are shown, it is to be understood at the outset of the description which follows that persons of skill in the appropriate arts may modify the invention here described while still achieving the favorable results of this invention. Accordingly, the description of the best mode contemplated of carrying out the invention, which follows, is to be understood as being a broad, teaching disclosure directed to persons of skill in the appropriate arts, and not as limiting upon the present invention.

Illustrative embodiments of the best mode of carrying out the invention are described below. In the interest of clarity, not all features of an actual implementation are described. In the following description, well-known functions, constructions, and configurations are not described in detail since they could obscure the invention with unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

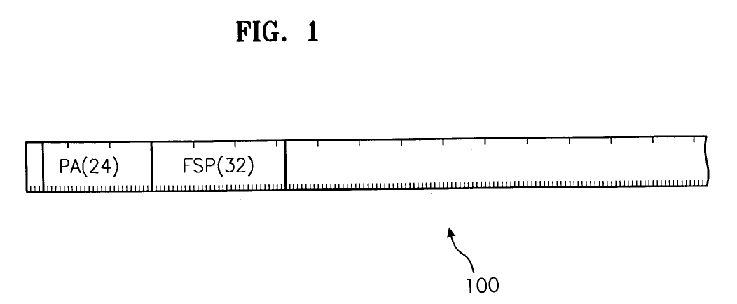

FIG. 1 is a diagram showing a frame structure for a mobile terminal. Relating to the frame structure 100 shown in FIG. 1, a synchronizing structure can allow a hop synchronization to be accomplished using a preamble pattern 24 in a frame, as shown in FIG. 1. Also, with reference to FIG. 1, frame synchronization is accomplished using a frame sync pattern 32, as shown in FIG. 1. However, the frame sync pattern may not be detected at all, or may be detected at different time positions according to a channel environment, so an undesirable situation such as a false alarm, a detection miss, or a sync-lost occurs.

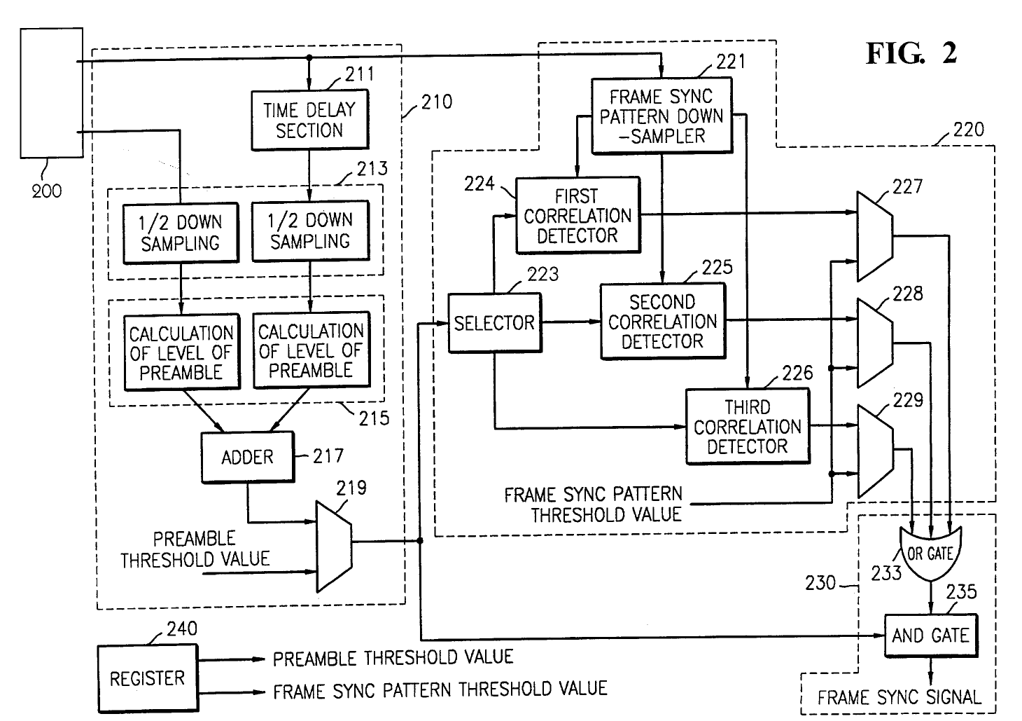

Hereinafter, the present invention will be described in detail with reference to FIGS. 2 through 7. FIG. 2 is a block diagram of a mobile terminal generating a frame sync signal, in accordance with the principles of the present invention.

The present invention relates to a method and structure for detecting a frame sync indicating the start of a frame, which is generated by a base station and is then received through a wireless channel. Detection of the frame sync is carried out through a series of processes such as matched filtering of a preamble pattern and interrelation between frame sync patterns. The structure for detecting frame sync is shown in FIG. 2.

A data frame is transmitted from a base station to a mobile terminal, and the data frame is divided into an I-channel and a Q-channel. The FIG. 2 shows an input unit 200 which receives frames through the I-channel and the Q-channel. The input unit 200, preamble detection unit 210, frame sync pattern detection unit 220, sync signal generation unit 230, and register 240 are included in a mobile terminal, in accordance with the principles of the present invention.

A register 240 stores a matched filter coefficient of a matched filter 215, correlation coefficients of correlation detectors 224, 225, and 226, a preamble threshold value, and a frame sync pattern threshold value. A preamble detection unit 210 includes the matched filter 215, which calculates the level of preamble of a signal received from a base station; an adder 217, which adds up the levels of an I-frame and a Q-frame, which are output from the matched filter 215; and a preamble comparator 219, which compares the output of the adder 217 with the preamble threshold value stored in the register 240 and outputs the result of comparison. A frame sync pattern detection unit 220 includes a selector 223 which selects one among the correlation detectors 224 through 226 and preamble sync pattern comparators 227 through 229. The preamble sync pattern comparators 227-229 can also be referred to as frame sync pattern comparators 227-229.

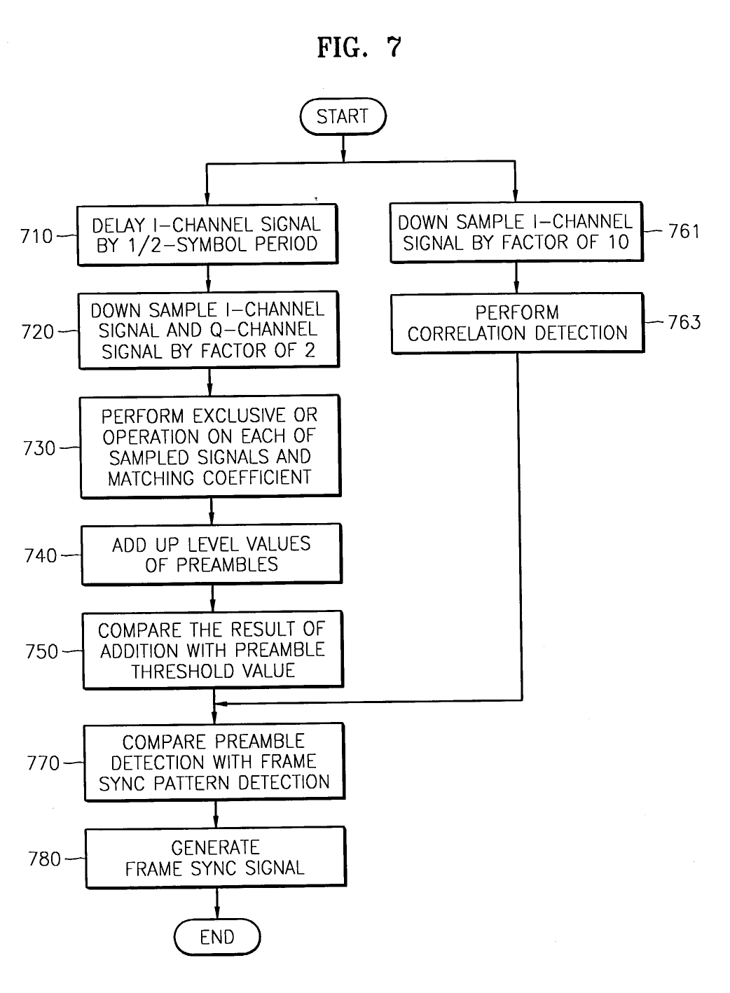

FIG. 7 is a flowchart of a method of generating a frame sync signal, in accordance with the principles of the present invention. In order to time between an I-channel signal and a Q-channel signal, which are received from a base station, a time delay section 211 delays the I-channel signal by a 1/2-symbol period (a period of five samples) in step 710 shown in FIG. 7. The 1/2-symbol period corresponds to 1/2 of a sampling period. Generally, in the case of Feher-patented quadrature phase shift keying (FQPSK) modulation, an I-frame signal leads a Q-frame signal by 1/2-symbol period. A preamble down sampler 213 down samples the I-channel signal and the Q-channel signal by a factor of 2 in step 720 shown in FIG. 7. Furthermore, 1/2 of the sampling period can be referred to as “sampling period/2”.

The 1/2-symbol period of the time delay section 211 can correspond to a first predetermined factor. The first predetermined factor can be altered. The factor of 2 that is used by the preamble down sampler 213 can be altered. The preamble down sampler 213 can down sample the I-channel signal by a second predetermined factor. The preamble down sampler 213 can down sample the Q-channel signal by a third predetermined factor.

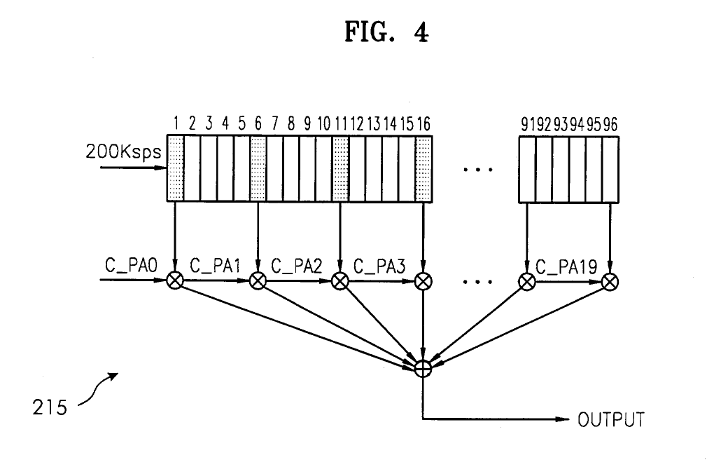

FIG. 4 is a diagram showing the structure of a matched filter of the mobile terminal shown in FIG. 2, in accordance with the principles of the present invention. As shown in FIG. 4, the matched filter 215 receives the I-channel signal and the Q-channel signal at a rate of 200 Ksps (200,000 symbols per second), samples each of them at a rate of 40 Ksps (40,000 symbols per second) using a shift register block, performs an exclusive OR operation on each of the sampled signals and a matching coefficient, adds up the results of the exclusive OR operations, and outputs the result of addition in step 730 shown in FIG. 7. The matching coefficient can correspond to a predetermined filter coefficient. The matching coefficients shown include C_PA0, C_PA1, C_ePA2, C_PA3, . . . , and C_PA19. Each of the I-channel signal and the Q-channel signal is a preamble signal and is composed of 24 bits. The adder 217 adds up the level values of the preambles in step 740 shown in FIG. 7.

In order to check whether a preamble pattern exists, the output of the adder 217 is compared with the preamble threshold value of the register 240, and it is determined that a preamble pattern has been received when the output of the adder 217 is greater than the preamble threshold value, in step 750 shown in FIG. 7.

The frame sync pattern detection unit 220 verifies determination of whether a preamble has been received using a frame sync pattern and guarantees that timing acquired in the preamble detection unit 210 is correct. A frame sync pattern down sampler 221 of the frame sync pattern detection unit 220 down samples the received I-channel signal by a factor of 10 in step 761 shown in FIG. 7. When the preamble comparator 219 outputs a signal confirming that a preamble has been received, the selector 223 selects one of the first through third correlation detectors 224, 225, and 226. The selected correlation detector 224, 225, or 226 performs correlation detection and outputs the result of correlation detection in step 763 shown in FIG. 7.

The preamble comparator 219 compares a preamble threshold value with the result of the adding up of the calculated levels performed by adder 217. Then the preamble comparator 219 outputs the timing information of the base station. That is, then the preamble comparator 219 outputs a first signal corresponding to the timing information of the base station. The preamble comparator 219 outputs the first signal to the selector 223 and to the AND gate 235, with the first signal corresponding to the timing information of the base station.

For example, when the selector 223 selects the first correlation detector 224, the first correlation detector 224 receives the output of the frame sync pattern down sampler 221, performs correlation detection, and outputs the result of correlation detection.

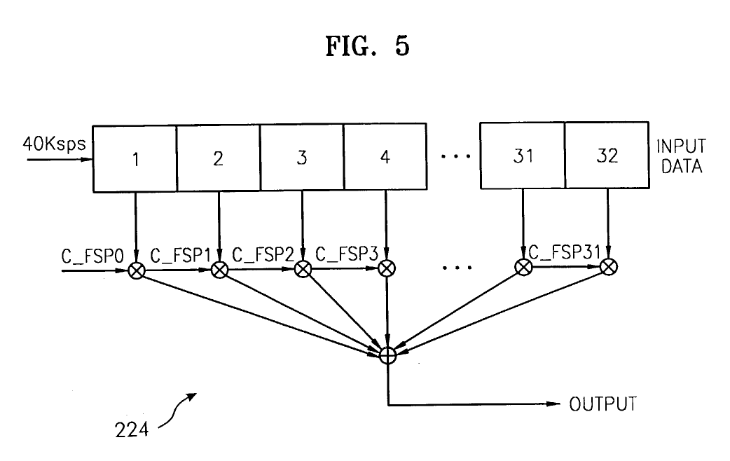

FIG. 5 is a diagram showing the structure of a correlation detector of the mobile terminal shown in FIG. 2, in accordance with the principles of the present invention. FIG. 5 depicts correlation detector 224 showing a structure for receiving 40 Ksps (40,000 symbols per second) input data obtained through 1/10 down sampling, performing an exclusive OR operation on each data and a coefficient of correlation, adding up the results of the exclusive OR operations, and outputting the result of addition. The coefficients of correlation shown in FIG. 5 include C_FSP0, C_FSP1, C_FSP2, C_FSP3, . . . , and C_FSP31. The input data shown in FIG. 5 include items 1 through 32.

In a case where one of the first through third correlation detectors constitutes a correlation detector, when it is assumed that the preamble detection unit 210 obtains timing information (for example, false alarm) at the front portion of a preamble pattern, the frame sync pattern detection unit 220 considers a signal input during a 32-symbol period as a frame sync pattern and determines whether the timing information obtained in the matched filter 215 is correct. However, since the correlation detector performs an operation on previous timing information, the frame sync pattern detection unit 220 reports that the timing information is not correct. Accordingly, correlation detection cannot be performed.

In order to prevent the above case where detection is not performed, as shown in FIG. 86, the three correlation detectors 224, 225, and 226 are used so that three preamble detection signals including the false alarm generated by the preamble detection unit 210 can be verified. As described above, when a frame sync signal is generated under the condition that preamble pattern detection and checking of a frame sync pattern are simultaneously performed, a false alarm rarely occurs. For example, when the preamble detection unit 210 detects and outputs three signals, the selector 223 selects the first correlation detector 224 for the first detection signal, the second correlation detector 225 for the second detection signal, and the third correlation detector 226 for the third detection signal, and the first through third correlation detectors 224, 225, and 226 perform the same operations and output the results of the operations.

The preamble sync pattern comparators 227 through 229 compare preamble detection values output from the respective correlation detectors 224, 225, and 226 with the frame sync pattern in step 770 shown in FIG. 7.

When a preamble detection value exceeds the frame sync pattern threshold value, a value of 1 is output from the corresponding preamble sync pattern comparator to an OR gate 233 included in a sync signal generation unit 230. The sync signal generation unit 230 can also be referred to as frame sync signal generation unit 230. An AND gate 235 included in the sync signal generation unit 230 performs an AND operation on the output of the OR gate 233 and the output of the preamble comparator 219 to generate a frame sync signal in step 780 shown in FIG. 7.

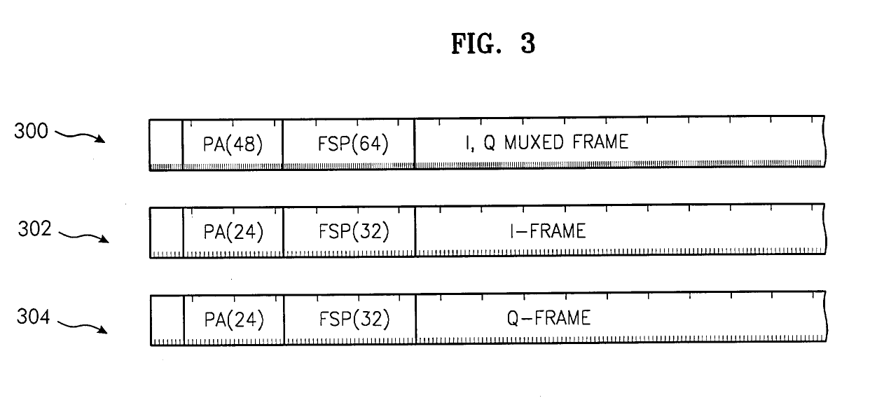

FIG. 3 is a diagram showing the structure of a frame received by a mobile terminal, in accordance with the principles of the present invention. Reference numeral 300 in FIG. 3 indicates preamble pattern 24, frame sync pattern 64, and I, Q multiplexed frame. Reference numeral 302 in FIG. 3 indicates preamble pattern 24, frame sync pattern 32, and I-frame. Reference numeral 304 in FIG. 3 indicates preamble pattern 24, frame sync pattern 32, and Q-frame.

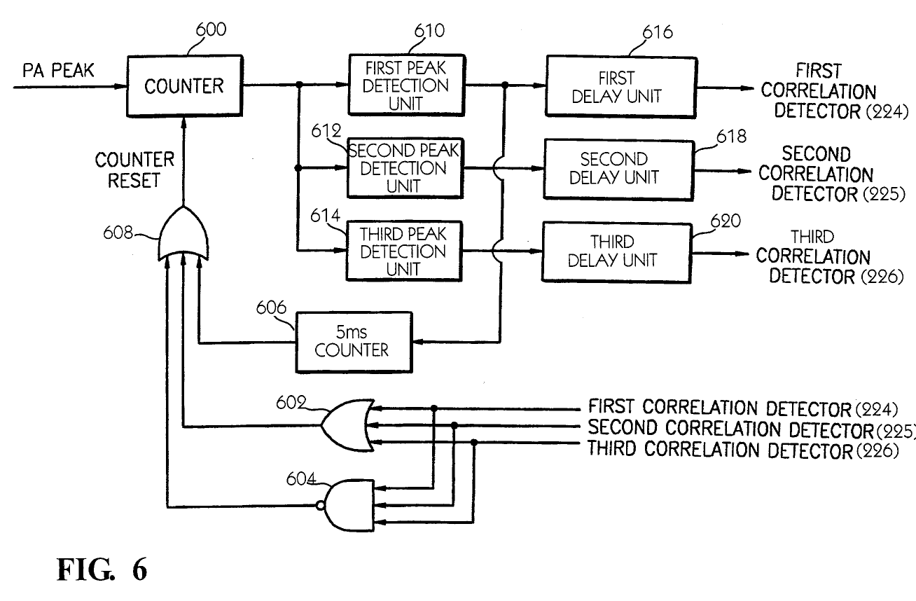

FIG. 6 is a diagram showing the structure of a selector 223 of the mobile terminal shown in FIG. 2, in accordance with the principles of the present invention. The selector 223 includes a counter 600, an OR gate 602, a NAND gate 604, a 5 millisecond (ms) counter 606 for counting milliseconds, an OR gate 608, a first peak detection unit 610, a second peak detection unit 612, a third peak detection unit 614, a first delay unit 616, a second delay unit 618, and a third delay unit 620.

The counter 600 counts the number of preamble (PA) peaks input from the preamble detection unit 210.

The OR gate 602 performs an OR operation on frame sync pattern peak signals detected by the first through third correlation detectors 224 through 226, respectively, and outputs the result of the OR operation.

The NAND gate 604 performs an AND operation on the frame sync pattern peak signals detected by the first through third correlation detectors 224 through 226, respectively, inverts the result of the AND operation, and outputs the result of the inversion.

When the OR gate 602 and the NAND gate 604 receive no signals from the first through third correlation detectors 224 through 226, the 5 ms counter 606 counts 5 ms on the basis of a preamble peak output from the first peak detection unit 610 and then outputs a reset signal.

The OR gate 608 performs an OR operation on the output of the 5 ms counter 606, the output of the OR gate 602, and the output of the NAND gate 604 and outputs a signal for resetting the counter 600. In other words, when the OR gate 608 receives one signal, it outputs the reset signal to the counter 600. When the OR gate 608 receives two signals, it outputs the reset signal to the counter 600 in 5 ms after first one of the two received signals is received. When the OR gate 608 receives all of the three signals, it immediately outputs the reset signal to the counter 600 using the NAND gate 604 so as to prepare the counter 600 for acquisition of sync of the next frame.

The first peak detection unit 610 detects a first preamble peak from the output of the counter 600. The second peak detection unit 612 detects a second preamble peak from the output of the counter 600. The third peak detection unit 614 detects a third preamble peak from the output of the counter 600.

The first delay unit 616 delays the first preamble peak by a period of 34 samples and then outputs the delayed first preamble peak as a signal for driving the first correlation detector 224. The second delay unit 618 delays the second preamble peak by the period of 34 samples and then outputs the delayed second preamble peak as a signal for driving the second correlation detector 225. The third delay unit 620 delays the third preamble peak by the period of 34 samples and then outputs the delayed third preamble peak as a signal for driving the third correlation detector 226.

The detected preamble peaks are delayed as described above in order to obtain preamble peaks satisfying a time difference between a peak of a preamble pattern and a peak of a frame sync pattern, which occurs due to the frame structure, from the peak of the frame sync pattern and a plurality of preamble peaks (that is, the three preamble peaks) generated due to false alarm or an accurate preamble peak. In other words, for accurate synchronization, among the preamble peaks generated due to false alarm or an accurate preamble peak, a preamble peak satisfying a time difference with the peak of the frame sync pattern is used as a sync signal in the system.

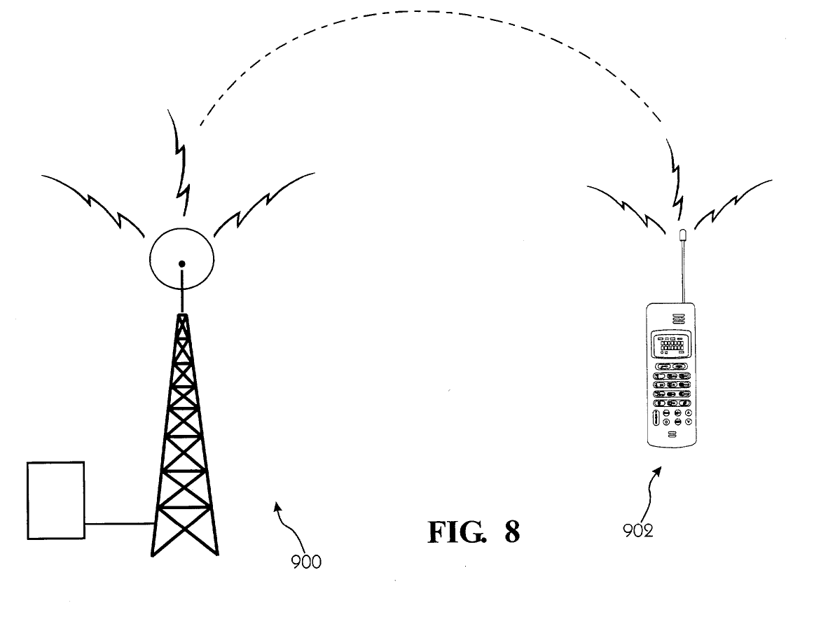

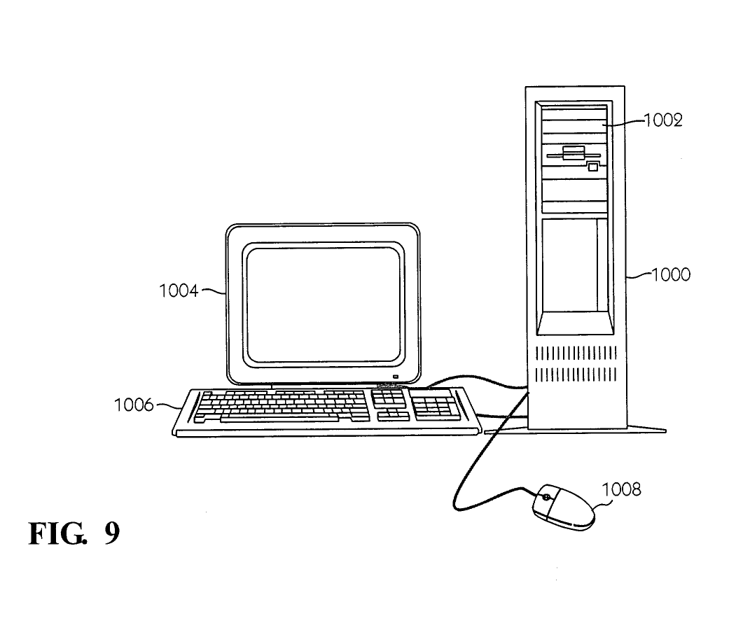

FIG. 8 is a diagram showing a base station and a mobile terminal, in accordance with the principles of the present invention. FIG. 8 shows base station 900 and mobile terminal 902. FIG. 9 is a diagram showing a computer system, in accordance with the principles of the present invention. FIG. 9 shows a computer system having a main body 1000, a hard disk drive 1002 for storing data corresponding to the method of the present invention, a display 1004, a keyboard 1006, and a mouse 1008. The main body 1000 can be referred to as the computer 1000.

A mobile terminal according to the present invention generates a frame sync signal, which is used as a reference for timing information necessary to restore a signal received from a base station. Accordingly, the present invention increases reliability of communication between a base station and a mobile terminal having a structure in which a detection error or false alarm rarely occurs.

The present invention can be realized as a code which is recorded on a computer readable recording medium and can be read by a computer. The computer readable recording medium may be any type of medium on which data which can be read by a computer system can be recorded, for example, a read only memory (ROM), a random access memory (RAM), a compact disc-read only memory (CD-ROM), a magnetic tape, a hard disk drive, a floppy diskette, a flash memory, an optical data storage device, or other storage unit. The present invention can also be realized as carrier waves (for example, transmitted through Internet or air). Alternatively, computer readable recording media are distributed among computer systems connected through a network so that the present invention can be realized as a code which is stored in the recording media and can be read and executed in the computers.

In an embodiment of the present invention, the above-described steps of the present invention can be instructions stored in a memory, and the instructions stored in the memory can be performed by one or more computers. The memory could be any kind of computer readable medium such as floppy disks, conventional hard disks, removable hard disks, compact discs (CDs), digital versatile discs (DVDs), flash read only memory (flash ROM), nonvolatile read only memory, and random access memory (RAM), for example. A computer system can be a personal computer (PC), a desktop computer 1000 shown in FIG. 9, a workstation, a server, a portable computer, a notebook computer, a hand-held computer, a palm-sized computer, a wearable computer, or any other type of computer system. The computer 1000 shown in FIG. 9 includes a hard disk drive 1002. The hard disk drive 1002 is one example of a computer readable medium.

In an embodiment of the present invention, at least one of the above-described steps of the present invention can correspond to an execution of instructions stored in one or more memory units. For example, one of these memory units could be the hard disk drive 1002 installed in the computer 1000. Instructions stored in such a memory unit can be executed or performed by one or more computers. For example, instructions corresponding to some of the steps of the present invention can be stored in the hard disk drive 1002.

A software implementation of the above-described embodiment may comprise a series of computer instructions either fixed on a tangible medium, such as computer readable media, for example a compact disc or a fixed disk, or transmissible to a computer system via a modem or other interface device over a medium. The medium can be either a tangible medium, including, but not limited to, optical or analog communications lines, or may be implemented with wireless techniques, including but not limited to microwave, infrared or other transmission techniques. The medium may also be the Internet. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, for example, shrink wrapped software, pre-loaded with a computer system, for example, on system read only memory (ROM) or fixed disk, or distributed from a server or electronic bulletin board over a network, for example, the Internet or World Wide Web.

As described above, according to the present invention, when a preamble detection unit detects a preamble pattern, and simultaneously a frame sync pattern detection unit checks a frame sync pattern, a detection error or false alarm rarely occurs. When the level of a threshold value in the preamble detection unit is appropriately lowered, although the probability of a false alarm for preamble detection is high, the probability of an error occurring during detection is lowered so that the frame sync pattern detection unit performs verification with respect to all false alarms. Thus, a detection error or false alarm is minimized.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit and scope of the applicant's general inventive concept.

What is claimed is:

1. A mobile terminal, comprising:
an input unit receiving frames from a base station, said input unit receiving the frames through an I-channel and a Q-channel;
a preamble detection unit detecting timing information of the base station from a preamble pattern of the received frames, said preamble detection unit including a plurality of outputs;
a frame sync pattern detection unit receiving the frames through the I-channel, receiving the frames from at least one output of said preamble detection unit, and verifying the timing information; and
a frame sync signal generation unit generating a frame sync signal in dependence upon an output of said frame sync pattern detection unit.

2. The mobile terminal of claim 1, further comprising:
a register storing at least one selected from among a threshold value and a coefficient, the threshold value being for said preamble detection unit, the coefficient being for said frame sync pattern detection unit.

3. The mobile terminal of claim 1, said preamble detection unit further comprising:
a time delay section delaying by a first predetermined factor the frames passing through the I-channel;
a preamble down sampler down sampling an output of said time delay section by a second predetermined factor and down sampling the frames passing through the Q-channel by a third predetermined factor;
a matched filter receiving the down-sampled frames from said preamble down sampler, said matched filter calculating levels of preambles of the down-sampled frames;
an adder adding up the outputs of said matched filter; and
a preamble comparator comparing an output of said adder with a preamble threshold value, said preamble comparator outputting the timing information of the base station.

4. The mobile terminal of claim 3, with the first predetermined factor being a delay time corresponding to (sampling period/2).

5. The mobile terminal of claim 3, with the second and third predetermined factors each corresponding to 2.

6. The mobile terminal of claim 3, with said matched filter performing exclusive OR operations on the down-sampled frames and predetermined filter coefficients, respectively, adding up the results of the exclusive OR operations, and outputting the result of the adding up of the results of the exclusive OR operations.

7. The mobile terminal of claim 1, said frame sync pattern detection unit comprising:
a frame sync pattern down sampler receiving at least one frame passing through the I-channel and down sampling the at least one received frame;
a correlation detector receiving the at least one down sampled frame from said frame sync pattern down sampler, and calculating the level of the at least one frame; and
a frame sync pattern comparator comparing an output of said correlation detector with a threshold value for a frame sync pattern.

8. The mobile terminal of claim 7, with said frame sync pattern down sampler down sampling the at least one frame passing through the I-channel by a factor of 10.

9. The mobile terminal of claim 1, with said frame sync signal generation unit performing an AND operation on the output of said preamble detection unit and the output of said frame sync pattern detection unit to generate the frame sync signal.

10. A method of generating a frame sync signal with a mobile terminal, the method comprising:
dividing a data frame received from a base station into a frame passing through an I-channel and a frame passing through a Q-channel, and inputting the divided frames;
down sampling the frame passing through the I-channel and the frame passing through the Q-channel, outputting a first signal when a preamble is received, and detecting timing information of the base station;
calculating a level of a frame sync pattern of the frame passing through the I-channel;
comparing a predetermined threshold value with result of said calculating; and
performing an OR operation on the first signal and the result of said comparing, said performing of the OR operation generating the frame sync signal.

11. The method of claim 10, with said down sampling, outputting, and detecting comprising:
delaying the frame passing through the I-channel by a period of time corresponding to a first predetermined factor;
down sampling the delayed frame by a second predetermined factor, and down sampling the frame passing through the Q-channel by a third predetermined factor;
calculating levels of the down sampled frames and adding up the calculated levels; and
comparing a preamble threshold value with the result of the adding up of the calculated levels, and outputting the timing information of the base station, the first signal corresponding to the timing information.

12. The method of claim 11, with the first predetermined factor corresponding to (sampling period/2).

13. The method of claim 11, with the second and third predetermined factors corresponding to 2.

14. The method of claim 10, with said calculating comprising:
comparing a frame sync pattern threshold value with the frame that passes through the I-channel, and outputting the result of said comparing of the frame sync pattern threshold value with the frame that passes through the I-channel.

15. A computer-readable medium having a set of computer-executable instructions for performing a method of generating a frame sync signal with a mobile terminal, the set of instructions comprising one or more instructions for:
dividing a data frame received from a base station into a frame passing through an I-channel and a frame passing through a Q-channel, and inputting the divided frames;
down sampling the frame passing through the I-channel and the frame passing through the Q-channel, outputting a first signal when a preamble is received, and detecting timing information of the base station;
calculating a level of a frame sync pattern of the frame passing through the I-channel;
comparing a predetermined threshold value with result of said calculating; and
performing an AND operation on the first signal and the result of said comparing, said performing of the AND operation generating the frame sync signal.

16. The computer-readable medium of claim 15, with said down sampling, outputting, and detecting comprising:
delaying the frame passing through the I-channel by a period of time corresponding to a first predetermined factor;
down sampling the delayed frame by a second predetermined factor, and down sampling the frame passing through the Q-channel by a third predetermined factor;
calculating levels of the down sampled frames and adding up the calculated levels; and
comparing a preamble threshold value with the result of the adding up of the calculated levels, and outputting the timing information of the base station, the first signal corresponding to the timing information.

17. The computer-readable medium of claim 16, with the first predetermined factor corresponding to (sampling period/2).

18. The computer-readable medium of claim 16, with the second predetermined factor corresponding to 2.

19. The computer-readable medium of claim 16, with the third predetermined factor corresponding to 2.

20. The computer-readable medium of claim 19, with said calculating of the level of the frame sync pattern of the frame passing through the I-channel comprising:
comparing a frame sync pattern threshold value with the frame that passes through the I-channel, and outputting the result of said comparing of the frame sync pattern threshold value with the frame that passes through the I-channel.
